(19) United States
(12) Patent Application Publication
(10) Pub. No.: US 2003/0049860 A1
(43) Pub. Date: Mar. 13, 2003

(54) Method and apparatus for NMR and spectroscopic solution analysis of immobilized molecules

(76) Inventor: Olivia M. Cholewa, Eugene, OR (US)

Correspondence Address: Bennett J. Berson, Quarles & Brady LLP, 1 South Pinckney Street, P O Box 2113, Madison, WI, 53701-2113, US

(21) Appl. No.: 10/242,369

(22) Filed: Sep. 12, 2002

Related U.S. Application Data
(60) Provisional application No. 60/322,048, filed on Sep. 12, 2001.

(51) Int. Cl. G01N 24/00

(52) U.S. Cl. 436/173; 436/171; 436/169; 422/56; 422/82.05; 422/99; 422/102; 422/940; 356/244; 356/246

(57) ABSTRACT

Analytical vessels for magnetic resonance or spectroscopic analysis comprise in their interior a fibrous substrate having bound to the surface thereof a molecule of interest having a characteristic spectrum. Conventional analytical methods employing the analytical vessels yield structural information about the molecule of interest. Also disclosed are methods for making, storing, cleaning, and reusing the analytical vessels of the invention.

### CROSS-REFERENCE TO RELATED APPLICATIONS

This application claims the benefit of provisional patent application No. 60/322,048, filed Sep. 12, 2001. The text of the provisional patent application and Exhibit A thereto are both incorporated by reference herein as if set forth in its entirety.

### BACKGROUND OF THE INVENTION

The present invention relates to novel methods and devices for atomic level structural studies on molecules, particularly biomolecules, bound to a silica-based fibrous substrate in an analytical vessel. As the art has recognized the biological importance of molecular structures, the need for tools and methods suited to the task has increased.

It is known in the art to immobilize molecules, including biomolecules, on solid substrates, such as glass plates, beads, particles, and wool. Nucleic acids, including RNA, DNA, PNA, and other synthetic nucleic acid molecules, proteins, peptides and other organic molecules, are conventionally attached, immobilized or tethered to surfaces for functional assays, hybridization studies and the like.

For detailed structural analysis of such molecules, on the other hand, the art relies upon crystallographic studies and solid-phase NMR analyses. These studies and analyses are inadequate for a number of reasons. X-ray crystallography is relatively unattractive for structural analysis of some types of nucleic acids because the molecules are not easily crystallized and because the crystal structure of these dynamic molecules is not representative of the structures of interest under biological (e.g., solution) conditions. The main disadvantage of solid-state NMR studies is that the studies must be carried out in the absence of solvent and therefore do not elucidate the actual physical characteristics in liquid conditions.

Solution nuclear magnetic resonance (NMR) spectrometry, with or without isotopic enrichment, is a popular method to structurally define RNAs under 160 nucleotides. One-dimensional (1D) ¹H-NMR can readily show exchangeable protons, imino (—NH), amino (—NH2), and hydroxyl (—OH) plus non-exchangeable protons, base aromatic (—CH), and sugar (—CH and —CH2). Both imino and non-imino proton resonances can be identified when comparing solvent exchange from H₂O to D₂O and noticeable differences in chemical shifts occur with changes in sample temperature, pH, and counterion concentration. By manipulating solution conditions, one can employ imino proton resonances to observe RNA fraying at the ends of double-stranded regions, or complete unwinding, because these protons are stable against exchange only when hydrogen bonded. Also, one can identify RNA structure by binding an intercalator (ethidium bromide, psoralen, acridine) having a ring current to the RNA to cause an upfield shift of the imino proton resonances.

One can more fully define RNA structures using homonuclear (¹H—¹H) or heteronuclear (examples: ¹H—¹³C; ¹³C—¹⁵N; ¹H—¹³C—¹H; ³¹P—¹H), two- or three-dimensional (2D and 3D) NMR, with or without selective isotopic labeling. Typical experiments utilize NOESY, COSY, TOCSY pulse sequences and/or creative variations of these formats. A number of RNA molecular structures have been well defined by analyzing the collected NMR data in conjunction with molecular dynamics software. Unfortunately, these analyses are very time consuming and labor intensive; therefore, only a few structures are defined per publication. Additionally, non-specific binding between RNA single-stranded regions and the sheer number of possible inherent conformations of dynamic single-stranded loop regions makes analysis of binding events and some NMR analyses problematic.

Still further, milligram quantities of material are required for suitable resolution in NMR studies. In the best cases, 50% of the small oligomer products synthesized using T7 RNA Polymerase and a DNA template are prematurely terminated and must be separated by polyacrylamide gel electrophoresis. For products smaller than 100 nucleotides, protocols used efficiently for longer nucleic acid strands are ineffective because of substantial losses of smaller unprotected oligomers. From 30 to 70% of sub-100 nucleotide products are lost during alcohol precipitation or size-exclusion bead desalting. Also, alcohol precipitation does not adequately remove all EDTA from solution. Still more losses can be incurred as a result of DNase or RNase contamination.

Where analysis under various conditions is desired, either additional sample must be obtained or the sample must be repurified between each test. This, coupled with large losses generally associated with the purification make it difficult to acquire sufficient sample for multiple independent analyses. Moreover, the existing analyses are conducted under dry conditions which can preclude acquiring relevant information about the structure of the molecules in their natural environment, be that aqueous or in the presence of other gases or liquids. The challenges associated with obtaining adequate amounts of a molecule increase when the molecule is small, rare, or volatile. Likewise, hazardous or poisonous materials can be difficult to work with when dried and unsecured.

Other strategies for immobilizing molecules for NMR analysis have been attempted with limited success. For example, available controlled pore glasses are not homogenous and it is difficult to diffuse materials of interest evenly throughout the pores. Inhomogeneity can contribute to peak broadening and other artifacts well known to those skilled in the art. Packed silica beads coated with a molecule of interest are not acceptable insofar as improper bead packing and bead loss render the time and amount of material required for analysis unacceptably high. Better methods and tools for enhancing NMR analyses of biomolecules are needed.

The art is familiar with covalent immobilization of silica-based ligands to the surface of chromatographic packing materials such as silica, alumina or highly crosslinked polymer particles in, e.g., high-performance liquid chromatography (HPLC), a widely used separation technology. The immobilized bonded phase can be polar (normal-phase or ion-exchange) or non-polar (reversed-phase, “RP”). The bonded phase of reversed-phase packings are derived by the chemical reaction of organosilanes with silanols (—SiOH groups) on the silica surface. Examples of common reversed-phase packings include methyl (C₁), ethyl (C₂), propyl (C₃), butyl (C₄), hexyl (C₆), octyl (C₈), octadecyl (C₁₈) and phenyl (Phe) ligands. Increased chain length results in longer retention and increased selectivity.

Bonded phase packing ligands have been physically characterized using a variety of methods with solid-state and solution NMR. Solid-state NMR studies use cross-polarization-magic angle spinning (CP-MAS) on dry chromatographic materials. Solution NMR studies use either ²H or ¹³C spectra (selectively isotopically labeled ²H, ¹³C or natural ¹³C) with Fourier transform nuclear magnetic resonance (²H or ¹³C FT-NMR). Deuterium is a quadrupolar (I=1) nucleus and is sensitive to perturbations in its environment. Selective ¹³C enrichment of surface and near-surface carbons was necessary to eliminate resonance overlap from other chain carbons because attached chains with multiple carbons and restricted mobility produce broad line spectra.

With solution NMR, rotational motion of the bonded phases in the presence of different mobile phases was assessed by measuring spin-lattice (longitudinal) relaxation time (T1). A decrease in T1 implies molecular association or decreased mobility. ²H T1 in suspensions were influenced by changes in surface character and are used to examine cooperative effects between the solvent, immobilized groups, and the surface. Association, binding, or hydration of water molecules with other species cause a decrease in T1, whereas addition of substances that disrupt water-water interactions causes an increase in T1. Unfortunately, solution NMR is time consuming, requiring at least one day to allow particles to settle in an NMR tube (longer if an air bubble was found), and still another day for 4,000 to 20,000 scans for one proton spectrum.

Three basic configurations describe how a hydrophobic bonded phase interacts with a mobile phase to form an interphase solvation layer that can retain solute molecules. The three configurations include

(1) “Bristle Brush”—a rigid configuration favored by a high bonded phase loading level prevalent with monomeric silanes. Very high bonding density leads to greater exclusion of mobile phase solvent from the interphase structure due to the high degree of chain cooperativity as well as decreased access to surface silanols. Also a fluid “bristle brush” exists when the bonded phase is exposed to a highly hydrophobic mobile phase and the bonded phase is essentially “dissolved” in the mobile phase.

(2) “Haystack”—found with an intermediate bonded phase loading level.

(3) “Blanket”—for lower bonded phase loading levels. Considering only steric issues, more surface space is available (from unreacted silanols) to accommodate the more disordered configuration. The “blanket” model is also found in highly aqueous mobile phases because the hydrophobic alkyl bonded chains will collapse or assume a folded configuration to minimize their surface contact with the polar mobile phase. At highly aqueous mobile phase compositions, the hydrophobic portion of the binary solution (acetonitrile or methanol) is likely entrapped in narrow-necked (“ink bottle”) pores beneath the collapsed alkyl chain structure.

The concepts of the hydrophobic bonded phase configurations have evolved from the early static models of the “bristle” or “blanket” concepts to the more recent dynamic models where bonded chains can undergo changes in orientation and mobility depending on various parameters such as temperature, solvent type and composition or cluster or aggregate under defined conditions. The dynamic model was further bolstered by studies that showed that alkyl chains possess a flexibility related to the mobile phase used and carbon content of the bonded phase. The model proposed that chains exist in various conformations with the range extrema going from rigid brushes to a convoluted form.

To further explain solute retention in RP systems Martire & Boehm (1983) proposed that organic enrichment of the surface (i.e. partitioning of organic mobile solvent into the chain lattice) as the basis of the “breathing surface” model. Sorption of solvent results in a swelling or increase of the surface layer thickness via modification of chain extension. The degree of chain interactions, with other chains and with mobile solvent molecules, determines the extent of solute partitioning, since any solute partitioning into the stationary phase must overcome these chain interactions in the adsorption process.

The art is limited by the inability to adequately investigate NMR and spectroscopic properties of substrate bound-molecules of interest without requiring significant time investment to obtain sufficient amount of each molecule and to prepare a sufficient number of samples for complete investigation.

### BRIEF SUMMARY OF THE INVENTION

The applicant here discloses NMR and spectroscopic analytical methods for structural study of a molecule of interest that address the shortcomings in the art, namely by employing in an analytical vessel a fibrous silica-based substrate material having the molecule of interest bound thereto. When provided in the analytical vessel in accordance with the invention, the fibrous substrate does not interfere with the magnetic (NMR) or optical spectra attributable to the molecule of interest. The fibrous substrate has a surface area sufficiently high that the molecule of interest can bind in an amount sufficient to generate a signal in the analytical method, but does not interfere with nuclear or electronic phenomena of the bound molecule. The fibrous substrate further facilitates in situ solvent diffusion without the need for particle settling/packing and resettling/repacking, as is needed for HPLC silica particle studies.

The present invention is a novel and unobvious intermediate between the expensive solid-state NMR techniques which, as noted, may not be appropriate for biological and other organic analyses, and solution NMR which is also not acceptable because of the difficulty in acquiring sufficient amounts of samples to be analyzed. Accordingly, for the first time known to the applicant, one can conduct atomic level structural studies on bound materials surrounded by their natural liquid or gaseous fluids, while avoiding the limitations that have hampered this art.

In addition to solving these problems, the invention is of great interest because it avoids the need for expensive solid-state NMR tools and the attendant technical challenges of preparing suitable samples for that equipment. Moreover, the present invention facilitates the rapid change of sample conditions and the rapid diffusion of samples into the fibrous substrate. The latter advantage permits one to study dynamic molecular reactions at the atomic structural level.

In a related aspect, the invention relates to the preparation of the analytical vessels. In accord with this aspect, the vessels are prepared at temperatures sufficiently low so as not to deform the analytical vessel or the fibrous substrate in a manner that interferes with the analysis, in a pH range in which a siloxane bond (—Si—O—Si—) is not hydrolyzed, and under conditions substantially free from contamination by agents that can degrade the molecule of interest (such as a DNase or RNase enzyme). The skilled artisan can use any chemistry operable within these constraints to covalently attach a molecule of interest to the fibrous substrate.

In accordance with the invention, a molecule of interest covalently attached to a solid fibrous substrate under suitable solvent conditions is sufficiently long to retain all relevant molecular motions exhibited by the free molecule in solution (e.g., rotation at single bonds, writhing throughout the length of a chain, long chain “scissoring”) except molecular tumbling. An additional degree of movement can be provided by tethering the molecule to the substrate via a linker, such that the tethered molecule can undergo a restricted form of tumbling, tethered tumbling. An example of a suitable linker can be a 6 to 18 unit linker alkyl chain.

In yet another aspect, the present invention relates to analytical methods for evaluating the molecule of interest by magnetic resonance or spectroscopic methods and related methods for preparing the analytical vessels for use and reuse. In accord with this aspect, the analytical vessels are cleaned and dried, then solvent is added to each as described herein before analysis. An NMR proton spectrum can be obtained with sixteen scans using a 300 MHz magnet (or sixty-four scans for a 250 MHz magnet) and a natural carbon-13 spectrum can be obtained with a minimum of two thousand scans, for a total of forty proton spectra and one carbon spectrum within one eight hour workday. Whereas prior methods require ²H- or ¹³C-bonded phase enrichment and at least two days per sample, the present invention does not require isotope enrichment and can prepare and analyze forty samples in the same time.

The invention is not intended to replace structural analysis by solution NMR. Instead, it provides an economical preliminary structural analysis that permits one to examine a wide variety of experimental conditions—including solvent conditions, salt/buffer and concentrations, and ligand selection—without concern for loss, excessive labor or batch differences (the same molecule is retained on the surface and retested, assuming that it the molecule is not covalently modified by a prior analysis).

In a process for coating the fibrous substrate, the substrate is placed into the analytical vessel prior to coating. After the coating (or bonded phase) is applied, the solvent is removed and the sample is stored under vacuum until analysis under conditions of interest is attempted. After analysis, the surrounding environmental solvent can be removed and the sample can be prepared once again for analysis under the same or different conditions. The application describes a preferred approach for keeping samples free of environmental or atmospheric contamination prior to use. The preferred approach involves a first vacuum aspiration step to remove excess visible liquid followed by a second vacuum drying step in which the tubes are placed in a storage vessel having a lid and an air tight septum in the lid through which a hypodermic needle attached to an external vacuum is removably inserted to withdraw any remaining solvent from the samples.

In addition to the uses detailed herein, the methods and products of the invention find particular utility, e.g., in analyses of new surface coatings, synthesis events, biological membrane dynamics, and the physical chemistry of hydrophobic: hydrophilic interactions and phase interaction phenomena.

It is an object of the invention to provide a solid support structure for a molecule that provides a solution environment for resonance or spectroscopic analysis of the molecule or of a binding event between the molecule and a ligand.

It is another object of the invention to provide preparation, purification and analysis methods having higher yields and lower losses than are achieved with existing methods.

It is a feature of the invention that the molecule of interest is covalently attached to a fibrous substrate or is covalently attached to a linker that is itself attached to the substrate.

It is another feature of the invention that the covalently attached molecule can freely change shape to achieve a biologically-relevant conformation in solution.

It is an advantage of the invention that reagents that contact the molecule of interest (e.g., solvents, buffers, salts, and unbound ligands) can be changed or removed with little or no loss of the molecule.

It is also an advantage of the invention that, unlike molecules provided in solution, the substrate-bound molecules do not form large aggregates or precipitate from solution. Under certain conditions, such as in the presence of alcohol, surface-attached oligomers of, e.g., RNA may form small aggregates similar to the “blanket” model, but much larger aggregates are not possible. The bound molecules exhibit behaviors similar to the bonded phase of RP models. In close enough proximity, single-stranded regions can stick to other single-stranded or double stranded regions through Watson-Crick and non-Watson-Crick hydrogen bonding; polar solvent molecules can be sequestered within an aggregation of strands; non-polar solvent molecules can adhere to the non-polar regions of linker chains creating hydrophobic pockets, or an RNA strand can hydrogen bond with unreacted silanols.

It is another advantage of the invention that non-specific binding between molecules can be reduced or eliminated relative to solution analysis conditions.

It is yet another advantage of the invention that the solid support structure can be repeatedly reused under a variety of experimental conditions for a host of investigations, with little or no loss of the bound molecule, thereby providing more rigorous binding assays and enhancing the resulting analysis.

It is yet another advantage of the invention that the ability to reuse the support structure eliminates the need for a large number of replicates of each tested molecule, thereby simplifying the experimental design, enhancing the test-to-test consistency, and reducing or eliminating losses attendant to reuse of samples in previous methods.

It is still another advantage of the invention that it avoids the need for expensive sample tubes such as are required for magic angle or fast spinning.

It is another advantage in that the methods of the invention can employ simple one-dimensional ¹H-FT NMR analysis, with or without solvent suppression, and can avoid exotic pulse sequences, isotope labeling or the use of a large number of scans.

Other objects advantages and features of the invention will become apparent upon consideration of the following detailed description of the invention.

### BRIEF DESCRIPTION OF THE SEVERAL VIEWS OF THE DRAWINGS

Not applicable.

### DETAILED DESCRIPTION OF THE INVENTION

The applicant herein discloses that analytical vessels, especially glass NMR tubes and quartz, glass and non-glass polymer (e.g., plastic) cuvettes, can be fitted with the fibrous substrate which can then be coated as disclosed with a molecule of interest before analysis. As is shown herein, the spectra obtained for molecules attached to the fibrous substrate are analytically acceptable and are comparable to controls lacking the fibrous substrate and to controls in which both the fibrous substrate and the molecule of interest are provided together in the analytical vessel without being bound to one another.

The fibrous substrate provided in each vessel type corresponds to the composition of the vessel—e.g., glass wool in glass tubes, quartz wool in quartz cuvettes, and plastic wool in plastic cuvettes. Ideally, the fibrous substrate is evenly distributed when packed in the analytical vessel. It was anticipated that unevenly hand-packed fibrous substrate would create magnetic field inhomogeneities for NMR analysis and that the silanols on the fibrous substrate could create a form of surface drag for some solvents, particularly for polar and long chain molecules rather than short, non-polar solvents. When the analytical vessels are hand-packed, certain tube-to-tube variations are observed. However, the variations observed are acceptable in this proof of principle.

It will be appreciated by the skilled artisan, however, that to the extent the clumping and discontinuities in the fibrous substrate are reduced or eliminated, better results are obtained. In the case of tubes, a thin brush can be employed to spool the fibrous substrate thereby reducing or eliminating clumping and discontinuities. The spooled material on the brush can then be placed into the analytical vessel. It is particularly advantageous to employ a plastic brush or comb that can be dissolved with an organic solvent. In such a case, after the spooled fibrous substrate is placed into the analytical, the organic solvent can be added to dissolve the plastic. The solvent containing the dissolved plastic can then be removed from the vessel leaving behind the evenly spooled glass wool.

A similar approach can be employed for evenly distributing the fibrous substrate in a cuvette. Evenly combed fibrous substrate can be secured in an opening in a frame that surrounds and provides structural support to the fibrous substrate. The frame can be formed from separate portions that can be joined together to secure the fibrous substrate in place or can be formed from a single hinged material folded to secure the fibrous substrate. Alternatively, the substrate can be packed into the cuvette, taking care to avoid clumping or discontinuities.

The applicant also discloses a preference for thinner fibers rather than thicker fibers. Thinner fibers yield a higher surface area per unit weight and thus one can bind more material to the fibers. The preference for thinner material is tempered by an understanding that as the fibers become brittle and tend to break, it is increasingly difficult to evenly distribute the fibers. As will be apparent from the attached, the method for ensuring that the fibrous substrate is evenly coated dictates that the fibrous substrate be placed in the analytical vessel before coating. Subsequent disturbance of that material can cause the fibers to break, thereby revealing uncoated surfaces that can interfere with the subsequent analysis.

The molecules to be applied to a surface of the fibrous substrate include materials that are themselves of interest for structural analysis in situ, such as novel bonded phases in the HPLC/separations industry and glass coatings applied in the glass-coating industry, where it is now quite difficult to study the behavior of such coatings in their natural fluid environments. Additionally or alternatively, the coatings can act as a linker to a separate molecule of interest. For example, in the attached, the bound molecule can have a first end reactive with the fibrous substrate and a second end reactive with, for example, a biological molecule (a “biomolecule”) which can be a nucleic acid, peptide, protein, a sugar, a lipid, a bifunctional dye, a drug, or other molecule of interest. In this case, the two molecules can be joined and then applied to the fibrous substrate, or the linker can be coated onto the fibrous substrate and then joined to the molecule of interest. The molecules to be applied can be any molecule that reacts with the surface of the fibrous substrate. Of particular interest are silanes that react via siloxane (Si—O—Si) bonds with glass surfaces, but the invention is not limited to such molecules, nor to those molecules that attach to the fibrous substrate via siloxane bonds. References herein to silanizing or silanization of the fibrous substrate are intended to refer broadly to derivatization or covalent attachment of the molecule of interest (or linker) to the substrate. By way of another example, RNA molecules such as tRNA, rRNA, mRNA comprise stem-loop structures (“hairpins”) that can act, e.g., as nucleation sites that can direct RNA folding, as regulators of biological activity that can shift the equilibrium between alternate structures, as recognition elements for protein interactions, and as protein-binding sites. It is particularly advantageous to directly or indirectly attach such molecules to the fibrous substrate in accord with the invention for subsequent analysis by NMR.

Various methods for making and using analytical vessels and coated fibrous substrates of the invention are described below.

Packing NMR Tubes

In a preferred method for packing the fibrous substrate into an NMR tube (preferably 5 mm×185 mm from Wilmad Glass Co., Inc., USA), a plurality of small tufts of the material (preferably, spun soft glass, 0.0009 in. to 0.0012 in. diameter, Fisherbrand®, Fisher Scientific, Pittsburgh, Pa.) are inserted into the tube using a glass rod (preferably 2 mm diameter), while avoiding packing the fibrous substrate unevenly or introducing extraneous materials (dust particles, non-glass fibers, etc). It is preferred that the packed tube contain no more than about 10 mg/cm of fibrous substrate in the bottom 3 cm of the tube to avoid unusual spectra and generally unsatisfactory results.

The fibrous substrate should be silanized after it is packed in the NMR tube because physical preparation of the material before loading can create sheared, unsilanized surfaces that can alter the surface characteristics. Moreover, it is more difficult to pack the silanized material because it tends to clump. Also, the preferred method avoids particulate contamination. In the preferred method, the uppermost 0.5 cm of the fibrous substrate is a physical barrier to entry of particulate contamination into the radio frequency (RF) field.

Attaching Molecules to the Fibrous Substrate in the Analytical Vessel

Silanization chemistry is well known, but established silanizing procedures are here adapted by the inventor to meet the constraints presented by the small confined volumes of analytical vessels employed in the invention. A user is free to select a suitable agent for binding to the fibrous substrate depending upon the goal of the researcher and can, upon appropriate reference to existing literature, determine a suitable solvent system for accomplishing that binding in the analytical vessel. A suitable silanizing agent requires no heating, refluxing or complex formulation. Numerous commercially available silanizing agents are known and commercially available. The applicant has identified halogenated silanes and carboxysilanes as particularly appropriate molecules for binding to the fibrous substrate. Particular reference is made to the silanizing agents commercially available from the Sigma, Fluka, and Aldrich catalogs, all of which are incorporated herein by reference. A suitable halogenated silane is dimethyloctylchlorosilane. Among carboxysilanes, 3-APTES is shown to be effective, although others can be selected with confidence.

A solution of approximately 7% polysiloxane in heptane, a commercial product available from Sigma Inc., St. Louis, Mo., USA under the brand name Sigmacote,® for use in silanizing glass plates for polyacrylamide gel electrophoresis, provides an example of a simple silanizing method. The simple air-drying method used to silanize glass plates is a preferred method for silanizing the fibrous substrates in the NMR tubes. The product of this silanizing method, employing other silanes dissolved in heptane, is readily analyzed by NMR as is shown elsewhere herein.

It should be noted that any molecule of interest can be covalently bound to the fibrous substrate in the analytical vessel where suitable chemistry is available for making the direct or indirect covalent attachment without violating the limitations on temperature, pH and contamination described elsewhere herein.

Cleaning NMR Tubes In Situ

A cleaning pipet, can be formed by packing a small wad of the fibrous substrate as a soft support into the neck of a 14 cm Pasteur pipet having an inner diameter greater than that of an NMR tube (preferably a disposable Borosilicate Glass Pasteur Pipet with Constriction; Fisherbrand®) from which the upper constriction has been removed.

An NMR Tube prepared as described above can be inverted and inserted into the cleaning pipet until the open end touches the fibrous wad. Sealing tape (preferably Teflon, approximately 20 cm) can be wrapped around the open end of the cleaning pipet to seal the opening between the pipet and the NMR Tube to form a cleaning assembly. The pipet tip end of the cleaning assembly can be placed into a 1 or 2 hole rubber stopper connected to a vacuum manifold that can retain the large amount of liquid aspirated during cleaning.

Where it is desirable to collect the liquid solvent from the NMR Tube, the cleaning pipet can be formed of a longer (e.g., 24 cm) Pasteur pipet and can be prepared without the fibrous wad, as the wad could react with the solvent in a manner similar to the action of activated charcoal. The vacuum chamber can be a 150 mL test tube having a plain NMR tube within. The long stem of the cleaning pipet is placed through a first hole in a two-hole stopper into the collecting NMR Tube, and the vacuum tubing is connected via a second hole in the stopper. Vacuum is applied and liquid is drawn through the cleaning pipet stem and tip into the collecting NMR tube. Optionally, a small container of dry ice can be placed outside the bottom of the test tube to form a dry ice vacuum pump trap. Using the setups described above, a plurality of tubes can be cleaned simultaneously.

Storing NMR Tubes

A half-gallon, wide-mouth Ball® Mason Jar (Alltrista Corp., Muncie, Ind.) having a Dome® lid can be modified for use as a storage container or as a vacuum- or chemical drying chamber for NMR Tubes. A small frustoconical rubber septum is inserted into a hole drilled into the middle of the lid. A metal crown extending downward into the jar is formed when the hole is drilled and is retained such that there is an interference fit between the crown and the septum, thereby maintaining an impervious chamber. With the septum and the crown of metal forming a seal about the hole, vacuum can be maintained for at least three months. Without the metal crown, vacuum is maintained for less than three hours. If the Mason jar is to be used as a vacuum drying chamber, the exterior of the jar should be wrapped in packaging tape as a precaution against implosion. NMR Tube holders can be provided in the jar. A suitable holder can be an break-resistant culture tube (e.g., polypropylene, 50 mL size) having a cushioning wad of fibrous substrate placed at the bottom of the tube to prevent breakage. For drying, the chamber can be maintained in an anhydrous state by providing a deliquescent material such as KOH pellets in the chamber, preferably in an break-resistant culture tube having a cap having one or more holes drilled therethrough.

The NMR tubes can be stored in the jar, with or without solvent. Only tubes that contain the same solvent should be stored together (e.g., tubes filled with D₂O should not be stored with tubes that contain benzene-d₆). Tubes that contain organic solvents such as vaporized benzene should not be stored with the plastic NMR tube caps on.

A Mason jar that contains NMR tubes under vacuum should never be directly opened to the surrounding air, to avoid picking up dust and to avoid absorbing atmospheric moisture or other protonated environmental vapors. Instead, the vacuum can be released by providing gas through a syringe needle connected by hosing to a gas line into the interior of the jar until the lid visibly swells. A preferred gas is desiccant-dried (e.g., over a Drierite-column), glass-wool-filtered tank nitrogen. Dry argon or dry, filtered air are acceptable alternatives.

Drying NMR Tubes In Situ

Excess liquid should be vacuum aspirated until the fibrous substrate in the tube appears dry. Tubes lacking tube caps are placed upright in the tube holders in the container and a tight seal is formed. A syringe needle attached to tubing connected to a vacuum trap/vacuum pump is inserted into the septa and the vacuum is applied for, e.g., 8 to 24 hours, until the material is dry. The drying time depends upon the nature of the solvent and the derivatized surface, as well as the number of tubes in the jar and the number of jars. At the end of drying time, the vacuum pump is turned off and the syringe is removed without dislodging the septa.

After flooding the Mason jar with dry, clean gas, the wool tubes should be removed and quickly covered with an NMR tube cap or just kept within the jar, the jar still sealed but flooded with gas until ready for analysis.

Removing Air Bubbles from NMR Tubes

Solvent is added to the NMR tubes up to about the top of the fibrous substrate (approximately 0.5 to 0.75 mL total volume), then are individually capped with NMR tube caps. The solvent is hand-whipped into the tube glass wool until no further hand-whipping changes the level of solvent relative to the wool. This is usually one or two strong applications of manual force. Air bubbles may be present and sometimes not, depending upon the derivatized surface and the solvent.

The caps are removed from each tube having air bubbles in the solvent and the tubes are placed inside ajar prepared as described above. The jar is sealed shut and a vacuum is applied briefly, usually for less than 5 minutes, until solvent percolates up each NMR tube but has not percolated out of the tubes. The vacuum is maintained by not dislodging the septa. The Mason jar is flooded with filtered, dry gas and the solvent that was percolating up the NMR tube retracts into the fibrous substrate. The process can be repeated until all air bubbles are removed from all tubes. In practice, most air bubbles are removed in the first attempt.

Preparing NMR Tubes for NMR analysis

To prepare an NMR tube for NMR analysis the fibrous substrate is repeatedly rinsed in a suitable solvent to remove the last solvent or reaction solution and then vacuum dried (overnight drying is usually sufficient). The tube is stored until use under vacuum in a dry chamber with or with the deliquescent material.

When the tube is to be used, the chamber is flooded with filtered, dry gas prior to opening the jar, and, after opening the jar, the deuterated solvent (0.5 to 0.75 mL) is added to each tube. Each tube is capped and the solvent is hand-whipped into the fibrous substrate. Air bubbles are removed by degassing as described. The tubes are re-capped. It is preferable that the solvent be flush with the wool level, but solvent levels above or below the wool are acceptable and no dramatic difference in spectra was noticeable in the tubes examined.

One can validate that a tube containing the underivatized substrate is suitably prepared by NMR analysis by comparing the tube to a solvent blank (an NMR tube with deuterated solvent but no fibrous substrate). Unsuitable tubes exhibit difficulty in shimming, show a very uneven baseline, skewed peaks or excessive broadening of the solvent peak compared to solvent blank. Such tubes should be repacked and re-prepared. To remove the fibrous substrate from an NMR tube, a stiff orthodonture wire having small hook formed at one end can be inserted and the material can be withdrawn, taking care not to scratch the inside tube surface.

### EXAMPLE 1

### NMR Tubes

The Example below reports on the derivatization of C₈ onto glass wool in NMR tubes prepared according to the invention via an siloxane bond and the proof of the principle underlying the invention. Other molecules such as the carboxysilane 3-AP were also derivatized onto glass wool in NMR tubes prepared according to the invention with comparable results.

Dimethyloctylchlorosilane (“C₈”), a reactive, hygroscopic chlorosilane, was stored in an air-tight container with Drierite per manufacturer's directions. HPLC-grade water (14-17 megaOhm-cm) was used in all reactions. All reaction solutions were mixed or measured in glassware dried in an oven at 95-100° C. for at least 1 week. Polypropylene containers and pipets were stored in a 65° C. dry incubator until use.

The fibrous substrate was glass wool. Sixteen tubes were silanized per batch. All NMR glass wool tubes were individually hand-packed as described. One ml of a solution of C₈ and Na-metal dried heptane (at either a 4.5:18 ratio [20% silane in solution or a 7.5:18 ratio [33% silane in solution]) was added to each validated NMR tubes and each tube was capped and hand-whipped to remove air bubbles from the fibrous substrate. Open NMR tubes containing the C₈/heptane solution were laid flat in the air stream of the hood for 46 hours. The excess C₈/heptane was vacuum-aspirated and the tubes were again laid flat in the hood for 21.5 hours. The open tubes were placed in a 42° C. incubator, tubes open, for 5 days and 7 hours. The tubes were washed four times with heptane with the fibrous substrate soaked in heptane twice, once for 23 hours and then for 3.5 hours. Excess liquid was vacuum aspirated and then the tubes were placed into the drying chamber without KOH pellets and vacuum dried for 19 hours. Twenty four tubes reacted with 20% C₈-silane plus sixteen tubes reacted with 33% C₈-silane were prepared. No significant difference was observed between the two levels.

The NMR experiments were performed at room temperature (297-299°K) in one of three instruments: Bruker Aspect-3000 console with either Bruker 250 MHz or 300 MHz magnets or Varian UNITY/INOVA 500 MHz magnet. For ¹H experiments, the 250 MHz magnet required, at most experiments, sixty-four scans to provide a good baseline; the 300 MHz and 500 MHz required only 16 scans for excellent, near noise-free or noise free baselines. Sixty-four scans were used occasionally with the 300 and 500 MHz instruments only to compare previous 250 MHz experiments with these instruments. Experiments for natural ¹³C required from 256 to 12,000 scans, dependent upon the concentration of the samples examined.

Data was processed using WinNMR or WinNUTS software. All data was baseline corrected, zero filled, Fourier transformed and phase corrected. Derivatized-wool tube spectra were calibrated and peaks assigned tentatively using residual protonated solvent peaks or added tetramethylsilane. All NMR spectra are in chemical shift (ppm).

The following types of NMR tubes were tested by the applicant.

1. NMR tube with only 0.5 to 0.75 mL liquid (designated “P” for plain)

2. NMR tube with underivatized glass wool (designated “PGW” for plain glass wool)

3. NMR tube with derivatized glass wool (designated “DW” for derivatized glass wool)

Throughout the spectra acquired for ¹H analysis, peak assignments were based on protonated solvent peaks. Peak assignments in the PGW spectra were not as exacting as P spectra because unevenly glass wool packing caused field inhomogeneities that result in line broadening. This problem was not encountered when P and PGW ¹³C spectra were compared. PGW ¹³C peaks were very sharp and peak assignments were measured accurately. Surprisingly, no major peak shifts were observed between P and PGW.

When P tubes containing octane in acetonitrile-d₃ (0.5 to 0.75 mL total volume) were compared with PGW tubes with octane in acetonitrile-d₃ (0.5 to 0.75 mL total volume)and with C₈-DW tubes with acetonitrile-d₃, it was also observed that glass wool does not alter peak assignment to any great extent. However, DW tubes did show major changes in peak assignments characteristic of a molecule bound on the substrate. The proton, and to some extent the carbon, magnetic character, were different. Some landmark peaks are similar to those of the free octane, but new peaks were also visible and some peak shifting was observed. The C₈-DW peaks are comparable in quality to the PGW peaks (and for this sample, were actually better, due to better wool packing). Trimethyloctylsilane would have been a more useful choice for comparison with C₈-DW, but the main focus was for peak quality rather than field assignment.

To determine the effect of octane and the effect of glass wool on the acetonitrile multiplet at 1.39 ppm and on the octane peaks, P:acetonitrile-d₃ was compared first to P:octane in acetonitrile-d₃ and then to PGW:octane in acetonitrile-d₃. Octane had no effect on the 1.39 ppm multiplet. The glass wool caused some loss of resolution at the bottom of the 1.39 ppm multiplet, but it remains a multiplet of seven peaks in PGW. The octane peaks again showed a minor amount of peak broadening.

¹H and ¹³C NMR spectra of P vs. PGW were compared for octane in water (D₂O), and then these were compared with C₈-DW in D₂O. Even though octane is insoluble in water a spectrum is possible for the insoluble molecule without the problem of phase separation because the dimethyloctyl-group is attached to the glass wool. The P and PGW tubes were octane:D₂O in equal amounts such that both solvents were equally in the RF field. An excessively broad peak observed in the C₈-DW spectrum was caused by the collapse of the octyl group into small surface globules to escape the water, a molecular variation on phase separation, but with less mobility of the octyl group due to this clustering and condensing.

It was further observed in C₈-DW tubes that a progressive change in the solvent concentration from an initial D₂O:acetonitrile ratio of 0.5:0 to a final ratio of 0:0.5 had a direct impact upon the ¹H NMR spectrum obtained for C₈-derivatized glass wool. Whereas the spectrum of the bound C₈ was a single broad indistinct peak at the initial solvent ratio, at least six separate sharp peaks were observed at the final solvent ratio. This indicates the ability to manipulate the environment of the bound molecule and to derive structural information about the molecule from the resulting changes.

Ten tubes containing C₈-DW in acetonitrile-d₃ were silanized, cleaned, dried and analyzed as a group lot. Any spectral variations would relate directly to tube-to-tube variation in wool packing and bonded phase amount. One superb spectrum was obtained; the others highlight the limitations of hand-packing.

### EXAMPLE 2

### Spectroscopy Cuvettes

Standard rectangular UV/Visible quartz cuvette with 2 mm cell path length (12.5 mm×4.5 mm×45 mm OD) and standard rectangular fluorescence quartz cuvette with 10 mm cell path length (12.5 mm×12.5 mm×45 mm OD, Spectrosil® Far UV Quartz windows, usable range 170 to 2700 nm, Starna Cells, Inc., Atascadero, Calif., USA) were packed with quartz wool (Alltech Associates, Inc., Deerfield, Ill., USA). This wool is much thinner than the wool used to fill NMR tubes (quartz wool=0.009 mm±0.002 mm, glass wool=0.0225±0.03 mm) and more brittle, making packing more difficult. A 1 mm flat length of laminate plastic was cut to fit the width of the cuvette. As with packing NMR tubes, small tufts were packed one on top of the other, avoiding clumps and uneven areas wherever possible.

Three UV/Vis cuvettes were packed—one was kept unsilanized as a wool control and two 2 mm UV/Vis cuvettes were silanized. Notwithstanding the effort to avoid differences among cuvettes, the three were not packed equally. The control cuvette contained more packing than the two silanized cuvettes, and one silanized cuvette contained slightly more packing than the other.

All four cuvettes were washed in acetone twice and dried prior to any experiments. The thin UV/Vis cuvettes were filled with solvent, hand-whipped gently with less force than was used for NMR tubes to get the solvent into the wool. Then the solvent was removed by hand-whipping the solvent from the cuvette into a wad of Kimwipes formed around the cuvette opening to avoid splashing solvent. Toxic solvents (cyclohexane, heptane, acetone) were “Kimwipe-whipped” with gloved hands, in a hood with the hood sash lowered for personal protection. Non-toxic solvents (water) were “Kimwipe-whipped” outside of the hood. The Kimwipe wad was replaced with dry Kimwipes when wet with solvent.

The 10 mm path-length fluorescence cuvette were filled with solvent, hand-whipped gently to get the solvent into the wool and then the solvent was poured out of the cuvette without hand-whipping because hand-whipping dislodged the wool packing from the fluorescence cuvette.

Prior to any silanization, the UV/Vis cuvettes were analyzed with a spectrophotometer (Hitachi U-3000, Hitachi Ltd., Tokyo, Japan) with 600 uL HPLC-grade water to determine the effect of the packing on light transmission. The settings were for a UV wavelength range from 190 to 320 nm (deuterium lamp), 2 nm slit, 2 mm path-length in the absorbance mode.

Using nomenclature similar to that used for the NMR tubes, “Plain cuvette” or “P” denotes no quartz wool in the cuvette; “Plain Quartz Wool” or “PQW” denotes underivatized quartz wool packing in the cuvette; “DW” denotes derivatized (silanized) wool packing in the cuvette.

Two of the three PQW cuvettes were soaked in an excess of water for 20 hours and were wrapped with Teflon tape to prevent scratching the cuvette surface. Excess water was hand-whipped out of the cuvettes and the cuvettes were placed on a glass wool pad on a 52° C. heating pad for 120 hours then vacuum dried for 8 hours and stored under vacuum until silanization.

The silanization protocol for the quartz wool cuvette was derived from U.S. Pat. No. 3,953,115, incorporated herein by reference as if set forth in its entirety. The method for silanizing optical glass was modified to accommodate the physical differences between the smooth glass surface of the patent and the very thin quartz wool confined within a small enclosed space of the cuvettes. The air drying step was allowed to proceed until all visible liquid was gone. The quartz wool cuvettes were kept in a humidity chamber for 7 hours at 40° C., as opposed to 1 hour at 90° C. in the patent, to allow water to diffuse into the cuvette. The lower temperature was chosen to prevent the possibility of cracking the cuvettes. The dry oven curing time is the same, 4 to 8 hours as recommended.

150 mg Bis (1-naphthyl)diethoxysilane (“BisN,” Sigma Inc., St. Louis, Mo., USA), a solid ethoxysilane that readily dissolves in benzene, was dissolved in benzene (4 mL). Approximately 50 to 200 uL were of the solution were added to the cuvettes—more for the fluorescence cuvette than for the UV/Vis cuvettes. The solution was hand-whipped to the bottom of cuvettes and allowed to air dry (usually 5.5 hours between applications) before another small aliquot was added and air dried again. A total of six applications were made in 31 hours. The final air drying step was for 30 hours. A powdery/crystal-like deposit was visibly distributed evenly throughout the length of all three cuvettes. All three cuvettes were placed in a humidity chamber/beaker for 27 hours at 40° C. and heat-cured for 6 hours. The cuvettes were again soaked in an excess volume of benzene for 12 hours. The cuvettes were rinsed five-times with benzene and five-times with cyclohexane and were then analyzed in cyclohexane, 190 to 360 nm. Only the cyclohexane peak was visible.

All cuvettes were rinsed four times more with cyclohexane, three times with isopropanol and three times with heptane. Spectra were taken in heptane, 190 to 360 nm. Additional washings revealed the importance of removing excess unreacted BisN from the cuvettes.

This work was done on an assumption that quartz wool within a quartz cuvette would not interfere with light transmission. It was reasoned that an light absorptive molecule attached to the surface of the quartz wool would retain its absorbency and the manipulation of this quartz wool cuvette (silanizing, cleaning, and preparation for analysis) would be uncomplicated.

The data showed that:

i) the detectable levels of light transmission are attained with the wool cuvettes,

ii) the wool does not interfere appreciably with the absorbance properties and detection of an added solute (rATP),

iii) and that an absorptive molecule (BisN) attached to the wool surface (presumably) also still retains its absorbance properties.

In a few additional preliminary infrared experiments, derivatized glass wool from the NMR tubes was extracted and gently teased over the expanse of KBr salt windows in solvent. The results obtained (data not shown) show that the glass wool does not interfere with infrared light transmission but the scans could not be compared to any published spectra. Analyzing a smear of derivatized-silica particles from HPLC packings between salt windows and salt presses for very fine particles are standard for the HPLC industry. The glass wool is much thicker than the largest silica packing and there are undoubtedly obstructive/optical phenomena that must be considered.

After purchasing the quartz glass wool and observing that it was much thinner than the common laboratory glass wool, attempts were made to pack quartz wool into NMR tubes. The quartz wool is much more brittle than spun soft glass wool and sheared into shorter strands than the common glass wool. The quartz wool was exceedingly difficult to pack. It crushed and clumped more readily and was generally difficult to retain a small tuft at the end of the glass rod. The thinner quartz wool would provide a much greater surface area that the common glass wool, but the packing problems must be resolved first.

I claim:

1. An analytical vessel for spectral analysis having an interior chamber comprising a fibrous substrate that does not interfere with magnetic or optical phenomena having bound thereto a molecule having a characteristic spectrum.

2. An analytical vessel as claimed in claim 1 where the vessel is selected from the group consisting of a glass NMR tube and a cuvette.

3. An analytical vessel as claimed in claim 2 where the cuvette is selected from a quartz cuvette, a glass cuvette and a plastic cuvette.

4. An analytical vessel as claimed in claim 1 wherein the fibrous substrate is selected from the group consisting of glass wool and quartz wool.

5. An analytical vessel as claimed in claim 1 wherein the molecule having a characteristic spectrum is a silane.

6. An analytical vessel as claimed in claim 1 wherein the molecule having a characteristic spectrum is a biomolecule.

7. An analytical vessel as claimed in claim 6 wherein the biomolecule is selected from the group consisting of a nucleic acid, a protein, a peptide, a sugar and a lipid.

8. An analytical vessel as claimed in claim 1 wherein the molecule having a characteristic spectrum is a biomolecule covalently linked to a silane.

9. A method for making an analytical vessel for spectral analysis of a surface-bound coating, the method comprising the steps of
providing in an analytical vessel a fibrous substrate that does not interfere with magnetic or optical phenomena;
attaching to the fibrous substrate a molecule having a characteristic spectrum; and
ensuring that the attached fibrous substrate in the analytical vessel remains free of environmental or atmospheric contamination until use.

10. A method as claimed in claim 9 where the vessel is selected from the group consisting of a glass NMR tube and a cuvette.

11. A method as claimed in claim 10 where the cuvette is selected from a quartz cuvette, a glass cuvette and a plastic cuvette.

12. A method as claimed in claim 9 wherein the fibrous substrate is selected from the group consisting of glass wool and quartz wool.

13. A method as claimed in claim 9 wherein the molecule having a characteristic spectrum is a silane.

14. A method as claimed in claim 9 wherein the molecule having a characteristic spectrum is a biomolecule.

15. A method as claimed in claim 14 wherein the biomolecule is selected from the group consisting of a nucleic acid, a protein, a peptide, a sugar and a lipid.

16. A method as claimed in claim 9 wherein the molecule having a characteristic spectrum is a biomolecule covalently linked to a silane.
